(19) United States
(12) Patent Application Publication
(10) Pub. No.: US 2025/0392402 A1
(43) Pub. Date: Dec. 25, 2025

(54) GATING SCHEDULING METHOD, CONTROLLER, NODE, AND COMPUTER READABLE MEDIUM

(71) Applicant: ZTE CORPORATION, Shenzhen, Guangdong (CN)

(72) Inventors: Xiangyang ZHU, Shenzhen, Guangdong (CN); Jinghai YU, Shenzhen, Guangdong (CN)

(21) Appl. No.: 18/880,508

(22) PCT Filed: Apr. 11, 2023
(86) PCT No.: PCT/CN2023/087533

§ 371 Date: Dec. 31, 2024

(30) Foreign Application Priority Data
Jul. 11, 2022 (CN) 202210808738.5

(51) Int. Cl. H04J 3/06

(52) U.S. Cl. CPC H04J 3/0667

(57) ABSTRACT

The present disclosure provides a gating scheduling method for a controller connected to a node, including: determining a target gate control list based on a target clock domain; and issuing the target gate control list and target gating parameter corresponding to the target gate control list to the node, the target gating parameter including a clock domain information parameter, and the clock domain information parameter representing information of a clock domain adopted for the target gate control list. The present disclosure further provides a gating scheduling method for a node, a controller, a node, and a computer readable medium.

### CROSS REFERENCE TO RELATED APPLICATIONS

The present disclosure claims the priority to Chinese Patent Application No. 202210808738.5 entitled “GATING SCHEDULING METHOD, CONTROLLER, NODE, AND COMPUTER READABLE MEDIUM” and filed with the CNIPA on Jul. 11, 2022, the contents of which are incorporated herein by reference in their entirety.

### TECHNICAL FIELD

Embodiments of the present disclosure relate to, but are not limited to, the technical field of communications, and in particular, to a gating scheduling method, a controller, a node, and a computer readable medium.

### BACKGROUND

A Time-Sensitive Network (TSN) can adopt a gating-based enhanced scheduling technique, where: a controller issues a gate control list to a node, and the node determines a state of a gate associated with each queue of an outlet port according to the gate control list, thereby determining whether the corresponding queue is allowed to be scheduled.

However, the gate control list is based on a Clock Domain (CD) which may be different from a default clock domain of the node, potentially leading to errors.

### SUMMARY

The present disclosure provides a gating scheduling method, a controller, a node, and a computer readable medium.

In a first aspect, an embodiment of the present disclosure provides a gating scheduling method for a controller connected to a node, including: determining a target gate control list based on a target clock domain; and issuing a target gating parameter to the node, the target gating parameter including the target gate control list and a clock domain information parameter, and the clock domain information parameter representing information of a clock domain adopted for the target gate control list.

In a second aspect, an embodiment of the present disclosure provides a gating scheduling method for a node connected to a controller, including: receiving a target gating parameter issued from the controller, the target gating parameter including a target gate control list and a clock domain information parameter, and the clock domain information parameter representing information of a clock domain adopted for the target gate control list; determining a final gating parameter at least according to the clock domain information parameter in the target gating parameter; and making the final gating parameter into effect.

In a third aspect, an embodiment of the present disclosure provides a controller, including at least one storage device and at least one processor; and the storage device stores a computer program executable by the at least one processor, and when the computer program is executed by the at least one processor, the gating scheduling method according to any embodiment of the present disclosure is implemented.

In a fourth aspect, an embodiment of the present disclosure provides a node, including at least one storage device and at least one processor; and the storage device stores a computer program executable by the at least one processor, and when the computer program is executed by the at least one processor, the gating scheduling method according to any embodiment of the present disclosure is implemented.

In a fifth aspect, an embodiment of the present disclosure provides a computer readable medium having stored thereon a computer program which, when executed by a processor, implements the gating scheduling method according to any embodiment of the present disclosure.

### BRIEF DESCRIPTION OF DRAWINGS

In the drawings of embodiments of the present disclosure:

FIG. 1 is a schematic diagram illustrating a principle of a gate control list in some related art;

FIG. 2 is a schematic diagram of clock domains to which nodes belong in some related art;

FIG. 3 is a flowchart illustrating a gating scheduling method for a controller according to an embodiment of the present disclosure;

FIG. 4 is a flowchart illustrating a gating scheduling method for a node according to an embodiment of the present disclosure;

FIG. 5 is a logic process diagram illustrating another gating scheduling method for a node according to an embodiment of the present disclosure;

FIG. 6 is a tree structure of gating parameters in another gating scheduling method according to an embodiment of the present disclosure;

FIG. 7 is a YANG structure in another gating scheduling method according to an embodiment of the present disclosure;

FIG. 8 is a logic process diagram of another gating scheduling method for a node according to an embodiment of the present disclosure;

FIG. 9 is a flowchart illustrating another gating scheduling method according to an embodiment of the present disclosure;

FIG. 10 is a schematic diagram of a message format of the PCEP protocol;

FIG. 11 is a schematic diagram of a format of a domainIdReq message in another gating scheduling method according to an embodiment of the present disclosure;

FIG. 12 is a schematic diagram of a format of a domainIdResp message in another gating scheduling method according to an embodiment of the present disclosure;

FIG. 13 is a logic process diagram of another gating scheduling method according to an embodiment of the present disclosure;

FIG. 14 is a block diagram of a controller according to an embodiment of the present disclosure;

FIG. 15 is a block diagram of a node according to an embodiment of the present disclosure; and

FIG. 16 is a block diagram of a computer readable medium according to an embodiment of the present disclosure.

### DETAIL DESCRIPTION OF EMBODIMENTS

In order to enable those of ordinary skill in the art to better understand the technical solutions of the present disclosure, a gating scheduling method, a controller, a node, and a computer readable medium provided in the embodiments of the present disclosure are described in detail below with reference to the drawings.

The present disclosure will be described more fully below with reference to the drawings, but the embodiments illustrated may be embodied in different forms, and the present disclosure should not be interpreted as being limited to the embodiments described below. Rather, the embodiments are provided to make the present disclosure thorough and complete, and are intended to enable those of ordinary skill in the art to fully understand the scope of the present disclosure.

The drawings for the embodiments of the present disclosure are intended to provide a further understanding of the embodiments of the present disclosure and constitute a part of the specification. Together with the specific embodiments of the present disclosure, the drawings are used to explain the present disclosure, but do not constitute any limitation to the present disclosure. The above and other features and advantages will become more apparent to those of ordinary skill in the art from the description of the specific embodiments with reference to the drawings.

The present disclosure can be described with reference to plans and/or cross-sectional views with the aid of idealized schematic diagrams of the present disclosure. Accordingly, the exemplary drawings may be modified according to manufacturing techniques and/or tolerances.

All the embodiments of the present disclosure and the features therein may be combined with each other if no conflict is incurred.

The terms used herein are merely used to describe the specific embodiments, and are not intended to limit the present disclosure. The term “and/or” used herein includes any and all combinations of one or more associated listed items. The terms “one” and “the” used herein which indicate a singular form are intended to include a plural form, unless expressly stated in the context. The terms “include” and “be made of” used herein indicate the presence of the described features, integers, operations, elements and/or components, but do not exclude the presence or addition of one or more other features, integers, operations, elements, components and/or combinations thereof.

Unless otherwise defined, all terms (including technical and scientific terms) used herein have the same meaning as commonly understood by those of ordinary skill in the art. It should be further understood that terms, such as those defined in commonly used dictionaries, should be interpreted as having a meaning that is consistent with a meaning in the context of the related technology and the background of the present disclosure, and should not be interpreted in an idealized or overly formal sense unless expressly so defined herein

The present disclosure is not limited to the embodiments illustrated by the drawings, but includes modifications to configuration formed based on a manufacturing process. Thus, regions shown in the drawings are illustrative, and shapes of the regions shown in the drawings illustrate specific shapes of regions of elements, but are not intended to make limitations.

In some related arts, the time-sensitive network can adopt the gating-based enhanced scheduling technique.

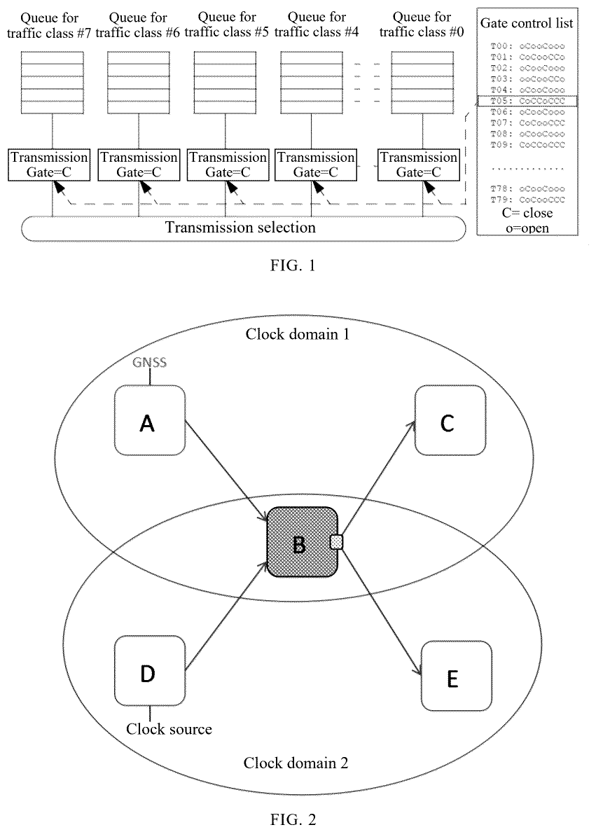

Referring to FIG. 1, with the gating-based enhanced scheduling technique, queues (Queue for traffic class #0-#7) of an output port are associated with gates (Transmission Gate); when a gate associated with a queue is in an ON state (O), it is indicated that a message of the queue is allowed to be scheduled; and when the gate is in an OFF state (C), it is indicated that the message of the queue is not allowed to be scheduled. The states of the gates are calculated by a controller, that is, the controller calculates the states of the gates associated with all the queues of the output port at each time or time slot (T00-T79) based on a selected clock domain, and issues to each node as a gate control list (Gate control list); and each node associates the gate control list with local time according to a default clock domain of the node, so as to determine the states of the gates at each time.

Different nodes may belong to different clock domains, and different service paths may reach a same output port through different nodes. Therefore, a node may belong to a plurality of clock domains. When a node belongs to a plurality of clock domains, each clock domain may adopt a different time synchronization protocol, for example, a clock domain 1 adopts the gPTP protocol, and a clock domain 2 adopts the PTP protocol. The node maintains a protocol instance for each clock domain, the time of each protocol instance is synchronized to a clock source of the respective clock domain. The protocol instances belonging to different clock domains are different in time, and one of the protocol instances is defined as a default clock domain.

In the related art, the clock domain used for generating the gate control list may be not matched with the default clock domain of the node, such that an error is caused.

For example, referring to FIG. 2, a first service passes through nodes A, B, C, which belong to a clock domain 1 (domain 1), a second service passes through nodes D, B, E, which belong to a clock domain 2 (domain 2); and thus, the node B belongs to both the clock domain 1 and the clock domain 2. Assuming that the node B takes the clock domain 2 as a default clock domain while the controller generates the gate control list based on the clock domain 1, an error is caused when the node B makes gating parameters, which are generated based on the clock domain 1, into effect according to the clock domain 2.

In a first aspect, an embodiment of the present disclosure provides a gating scheduling method for a controller connected to a node.

The embodiment of the present disclosure is configured to be implemented by the controller in a network (e.g., a time-sensitive network), and the controller is connected to one or more nodes (or network devices).

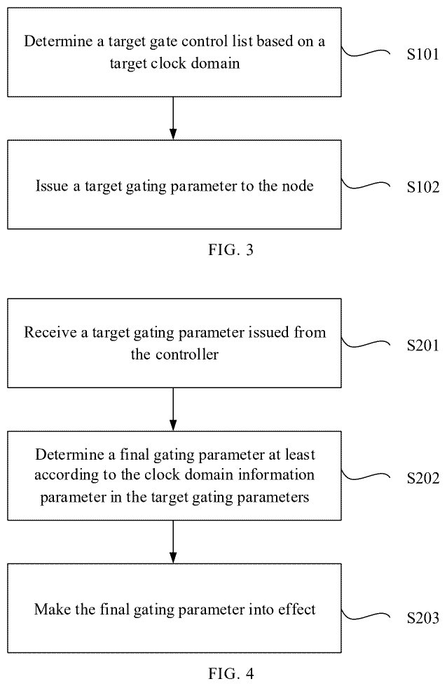

Referring to FIG. 3, the gating scheduling method according to the embodiment of the present disclosure includes the following operations S101 and S102.

At S101, a target gate control list is determined based on a target clock domain.

The controller generates a gate control list (i.e., the target gate control list) based on a clock domain (i.e., the target clock domain).

The target clock domain is an existing clock domain in a network to which the controller belongs, and may be obtained by presetting or calculation.

At S102, a target gating parameter is issued to the node.

The target gating parameter includes the target gate control list and a clock domain information parameter, and the clock domain information parameter represents information of the clock domain adopted for the target gate control list.

When the controller issues a gating parameter (i.e., the target gating parameter) including a gate control list (i.e., the target gate control list), the “clock domain information parameter” is added to the target gating parameter, and the “clock domain information parameter” may represent the information of the clock domain adopted for the target gate control list. Thus, after receiving the gating parameters, the node may determine, according to the clock domain information parameter, the clock domain based on which the target gate control list is generated, and determine whether the clock domain is matched with a default clock domain of the node, so as to avoid causing an error.

In the embodiment of the present disclosure, the gating parameters issued from the controller include the clock domain information parameter, so that the node can determine, according to the clock domain information parameter, the clock domain used for generating the gate control list, thereby avoiding the error caused by a mismatch between the clock domain of the gate control list and the default clock domain of the node.

A type and a length of the clock domain information parameter (denoted by adminDomainId) need to conform to a clock domain identification format of a corresponding time synchronization protocol, and may conform to clock domain identification formats of a plurality of time synchronization protocols. For example, in the PTP protocol defined by 1588v2, a clock domain is identified by an 8-bit integer value in a range of 0 to 255; and in the gPTP protocol defined by 802.1AS-Rev, a clock domain identification consists of two parts, i.e., an 8-bit integer number and a 16-bit constant (denoted by sdoId), a value range of the integer number is 0 to 127, and a value range of sdold is 0 to 100. Therefore, adminDomainId may be a 24-bit integer parameter or a choice-type parameter, or may be represented by a combination of a plurality of parameters.

The clock domain information parameter is issued to the node via a southbound interface, and the content of the information of the clock domain needs to be consistent with a parameter management model of the node. For example, an adopted southbound protocol may be NETCONF, PCEP, BGP, SNMP or the like, and a data model of the node may be a YANG model, an MIB management model or the like. Illustratively, when the BGP southbound protocol is adopted, a protocol message needs to be extended; and when the NETCONF protocol is adopted, a protocol itself does not need to be extended, and merely a corresponding YANG interface format needs to be extended.

The clock domain information parameter and the protocol may adopt various specific forms in the embodiment of the present disclosure, as long as it is ensured that the clock domain information parameter can be added to a southbound message, and the node can confirm and process the clock domain information parameter in the gating parameters by means of packet capture or by other means.

In some embodiments, the clock domain information parameter includes an unspecified identification or a target clock domain identification; and the unspecified identification represents that the target gate control list adopts the default clock domain of the node, and the target clock domain identification represents that the target gate control list adopts the target clock domain.

As an implementation of the embodiments of the present disclosure, the clock domain information parameter may be the target clock domain identification, which is an identification (ID) representing the target clock domain; or, the clock domain information parameter may be the unspecified identification instead of some specific clock domain identification, and the unspecified identification represents that no specific clock domain is designated, so that the default clock domain of the node may be adopted.

The unspecified identification may take various specific forms. For example, the unspecified identification may be “null”, that is, the clock domain information parameter may not have a specific value; or, the unspecified identification may be a specific value which is set in advance.

As can be seen, by using the unspecified identification, the clock domain information parameter may not include a specific clock domain identification, so as to be compatible with an existing protocol and an existing processing mechanism.

In some embodiments, the target gating parameter further includes an effective time of the target gate control list.

As an implementation of the embodiments of the present disclosure, the target gating parameter may further include the effective time (denoted by adminBaseTime) of the target gate control list, which represents a time when the gate control list comes into effect.

In some embodiments, the clock domain information parameter further includes: a type of the target clock domain.

As an implementation of the embodiments of the present disclosure, the clock domain information parameter may further include the type of the target clock domain, such as a PTP type or a gPTP type.

In a second aspect, an embodiment of the present disclosure provides a gating scheduling method for a node connected to a controller.

The embodiment of the present disclosure is configured to be implemented by the node (a network device) in a network (e.g., a time-sensitive network), and the node is connected to a controller.

Referring to FIG. 4, the gating scheduling method according to the embodiment of the present disclosure includes the following operations S201 to S203.

At S201, a target gating parameter issued from the controller is received.

The target gating parameter includes a target gate control list and a clock domain information parameter, and the clock domain information parameter represents information of a clock domain adopted for the target gate control list.

At S202, a final gating parameter is determined at least according to the clock domain information parameter in the target gating parameter.

At S203, the final gating parameter is made into effect.

In the embodiment of the present disclosure, the target gating parameter received by the node includes the clock domain information parameter, so that the node can determine, according to the clock domain information parameter, the clock domain adopted for the target gate control list and further determine the final gating parameter matched with a default clock domain of the node, and make the final gating parameter into effect, so as to avoid causing an error.

In some embodiments, the clock domain information parameter includes an unspecified identification or a target clock domain identification; and the unspecified identification represents that the target gate control list adopts the default clock domain of the node, and the target clock domain identification represents that the target gate control list adopts a target clock domain.

As an implementation of the embodiments of the present disclosure, the above clock domain information parameter may be the above target clock domain identification or the unspecified identification.

In some embodiments, determining the final gating parameter at least according to the clock domain information parameter in the target gating parameter includes:
responsive to the clock domain information parameter including the unspecified identification, determining the target gating parameter as the final gating parameter;
responsive to the clock domain information parameter including the target clock domain identification and the target clock domain equal the default clock domain of the node, determining the target gating parameter as the final gating parameter; and
responsive to the clock domain information parameter including the target clock domain identification and the target clock domain different from the default clock domain of the node, determining a timestamp difference between the target clock domain and the default clock domain; and determining the final gating parameter based on the timestamp difference and the target gating parameter.

As an implementation of the embodiments of the present disclosure, in the case where the clock domain information parameter includes the unspecified identification (for example, adminDomainId is null), it is indicated that the node is allowed to directly adopt the default clock domain (denoted by defaultDomainId) of the node, and therefore, the target gating parameter are directly taken as the final gating parameter, that is, the target gating parameter are directly made into effect.

In the case where the clock domain information parameter includes the target clock domain identification and the target clock domain indicated by the target clock domain information is the default clock domain to the node (for example, adminDomainId is equal to defaultDomainId), the target gating parameter may be also taken as the final gating parameter directly, that is, the target gating parameter are directly made into effect.

In the case where the clock domain information parameter includes the target clock domain identification and the target clock domain indicated by the target clock domain identification is different from the default clock domain of the node (for example, adminDomainId is not null and is not equal to defaultDomainId), the timestamp difference (denoted by offset) between the two clock domains, i.e., a time offset between the two clock domains at a same moment, needs to be calculated. For example, a current timestamp of the target clock domain is t1, and a current timestamp of the default clock domain is t2, then offset=t1−t2. Then, the target gating parameter may be adjusted according to the timestamp difference, and the adjusted gating parameter is taken as the final gating parameter to be made into effect.

In some embodiments, the target gating parameter further include an effective time of the target gate control list; and determining the final gating parameter based on the timestamp difference and the target gating parameter includes: correcting the effective time in the target gating parameter based on the timestamp difference to obtain the final gating parameter.

As an implementation of the embodiments of the present disclosure, adjusting the target gating parameter based on the timestamp difference may specifically include adjusting the effective time (adminBaseTime) of the target gate control list based on the timestamp difference, e.g., shifting adminBaseTime by offset, taking the target gating parameter obtained after the shifting as the final target gating parameter, and making the final target gating parameter into effect.

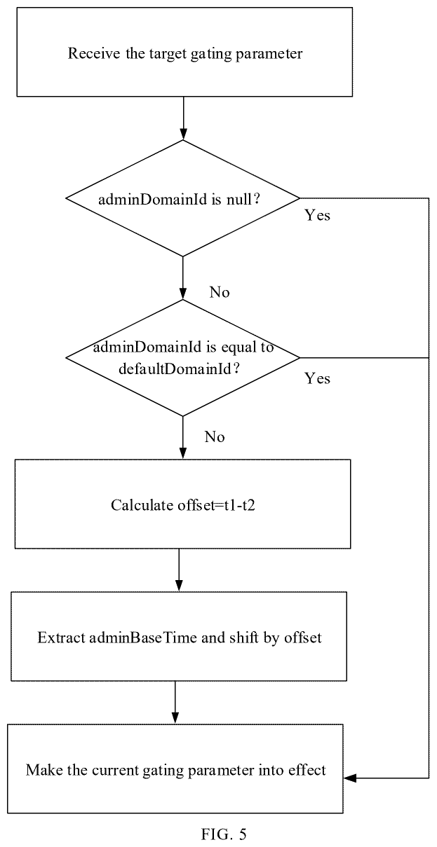

The above implementation may be specifically implemented in various processes. For example, referring to FIG. 5, after receiving the target gating parameter, the node first determines whether adminDomainId in the target gating parameter is null; if adminDomainId is null, the current gating parameters are directly made into effect, and if adminDomainId is not null, the node continues to determine whether adminDomainId is equal to defaultDomainId; if adminDomainId is equal to defaultDomainId, the current gating parameters are directly made into effect, and if adminDomainId is not equal to defaultDomainId, offset is calculated by offset=t1−t2, adminBaseTime is extracted and is shifted by offset, and then the current gating parameters are made into effect.

In addition to the above description, other procedures (a gating enhanced scheduling procedure and a sending procedure) of the node may be kept unchanged after the gating parameters are made into effect, and will not be described in detail in the embodiments of the present disclosure.

### EXAMPLE I

A specific process of the gating scheduling method according to an embodiment of the present disclosure is described in detail below.

NETCONF is adopted as the southbound protocol, and a gating parameter interface is described through a YANG model.

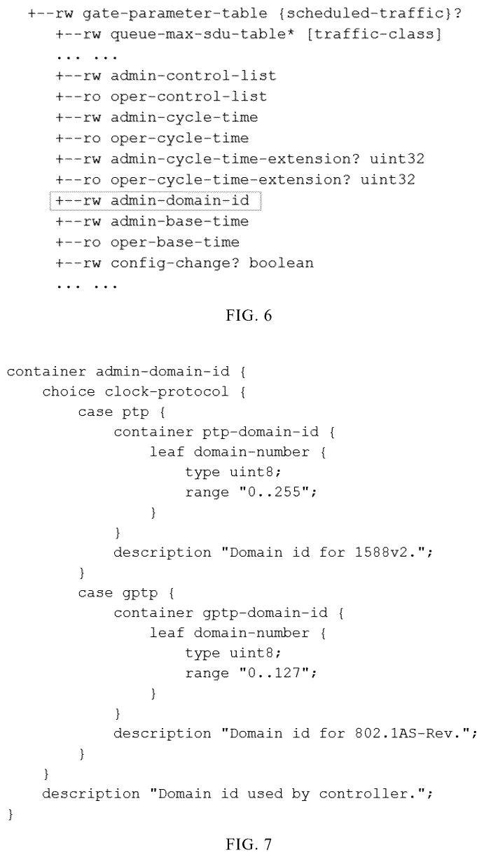

The YANG model may be extended based on a gating scheduling YANG interface defined by 802.1Qcw, and a container node is added under gate-parameter-table and is named admin-domain-id (i.e., adminDomainId); and FIG. 6 shows a tree structure of the gating parameters obtained after the extension.

The admin-domain-id may support two protocol types, and is represented a choice-type node in the embodiments of the present disclosure, and choice has two value types, i.e., PTP and gPTP. The two types may be distinguished by wrapping a container node under case, and FIG. 7 illustrates an example of the YANG structure.

The controller issues the gating parameters to a node A, the node A belongs to two gPTP clock domains, i.e., a clock domain 1 and a clock domain 2, a value (domainNumber) of a clock domain identification of the clock domain 1 and a value (domainNumber) of a clock domain identification of the clock domain 2 are 1 and 2 respectively, and a time difference between the clock domain 1 and the clock domain 2at a same moment is offset12=+100. The clock domain 1 is pre-configured as a default clock domain of an output port p1 (port 1) of the node A, that is, a value of defaultDomainId is 1.

The controller generates the gate control list based on the clock domain 2. Therefore, in the gating parameters issued from the controller, a value of adminDomainId is 2, a type is gPTP, and a value of adminBaseTime is 10000.

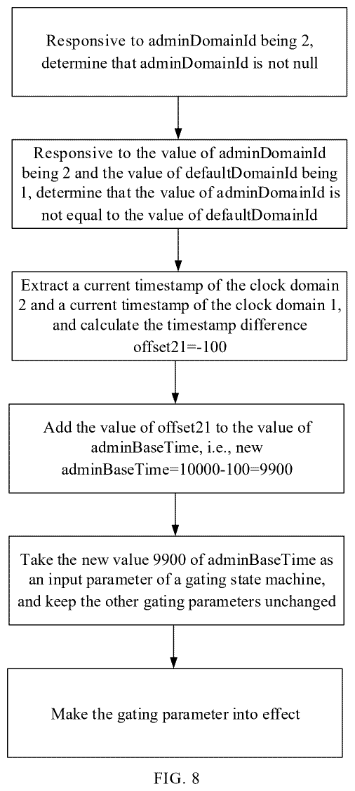

Referring to FIG. 8, a gating scheduling process performed by the node A may include:
A1, responsive to adminDomainId being 2, determining that adminDomainId is not null;
A2, responsive to the value of adminDomainId being 2 and the value of defaultDomainId being 1, determining that the value of adminDomainId is not equal to the value of defaultDomainId;
A3, extracting a current timestamp of the clock domain 2 and a current timestamp of the clock domain 1, and calculating the timestamp difference offset21=−100;
A4, adding the value of offset21 to the value of adminBaseTime, i.e., new adminBaseTime=10000−100=9900;
A5, taking the new value 9900 of adminBaseTime as an input parameter of a gating state machine, and keeping the other gating parameters unchanged; and
A6, making the gating parameters into effect.

### EXAMPLE II

Referring to FIG. 9, a gating scheduling method according to an embodiment of the present disclosure may include:
S301, acquiring, by the controller, information of a default clock domain of the node;
S302, generating, by the controller, a target gate control list based on the default clock domain of the node; and
S303, issuing, by the controller, target gating parameter to the node.

The target gating parameter include the target gate control list.

As another implementation of the embodiments of the present disclosure, the controller may acquire the information of the default clock domain (defaultDomainId) of each node; and then the controller may generate, when performing gating path calculation, target gate control lists by using the respective default clock domains of the nodes as target clock domains (which may be also understood as generating a gate control list according to a specified target clock domain and then adjusting part of the gate control list or the entire gate control list according to defaultDomainId of each node), so as to obtain the target gate control lists which conform to the default clock domains of the nodes; and then the controller may directly issue the target gate control lists to the corresponding nodes.

As such, when receiving the target gating parameter, each node may directly take the target gating parameter as the suitable target gating parameter, so that each node may directly make the target gating parameter into effect.

The controller may acquire the information of the default clock domains of the nodes in various specific manners.

For example, the controller may issue a request to each node (for example, when the controller needs to perform gating path calculation), and the nodes report the information of the respective default clock domains according to the requests.

As another example, each node may actively report the information of the default clock domain thereof (for example, when the node has access to the controller or the default clock domain of the node is changed).

A specific protocol according to which the controller acquires the information of the default clock domains of the nodes and a specific format of the acquired information are various, and will not be described in detail herein.

A specific process of the gating scheduling method according to the embodiment of the present disclosure is described in detail below.

In the embodiment of the present disclosure, the controller requests the nodes to report the information of the default clock domains through the PCEP protocol.

The controller issues domainIdReq request messages through the PCEP protocol, and the content of the message includes, but is not limited to, nodeId and portId.

After receiving the domainIdReq request messages, the nodes return domainIdResp response messages to the controller, and the content of the message includes, but is not limited to, a time synchronization protocol type (clockProtocol) adopted by the node and the information of the default clock domain (defaultDomainId).

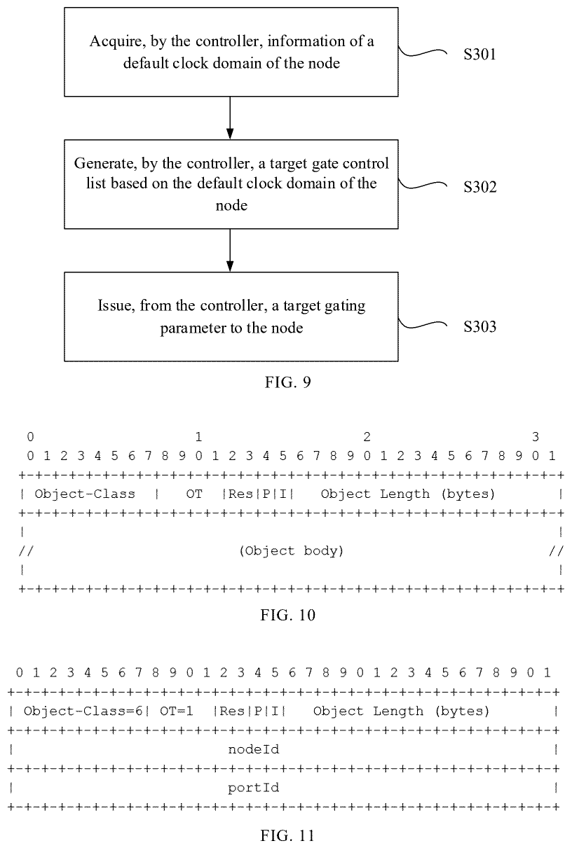

The PCEP protocol provides a protocol message extension mode, which facilitates definition and extension of a new message type. For example, referring to FIG. 10, an Object-class field and an OT field of a PCEP protocol message may be configured to indicate a message type, a value range of Object-class is 1 to 255, a value range of OT is 1 to 15, and an Object-body field is needed to be an integer multiple of 4 bytes.

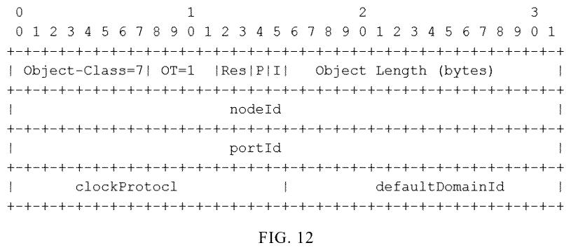

In this embodiment, the following may be defined:
referring to FIG. 11, when the value of Object-class is 6 and the value of OT is 1, the message is a domainIdReq message; and moreover, node-id occupies 4 bytes, and port-id occupies 4 bytes; and
referring to FIG. 12, when the value of Object-class is 7 and the value of OT is 1, the message is a domainIdResp message; and moreover, node-id occupies 4 bytes, port-id occupies 4 bytes, clockProtocol occupies 2 bytes, and defaultDomainId occupies 2 bytes.

After receiving the information of defaultDomainId reported by the domainIdResp messages from the nodes, the controller performs gating path calculation according to defaultDomainId of the nodes, and issues gating parameter lists to the nodes after completing the path calculation, and the nodes make the gating parameters into effect.

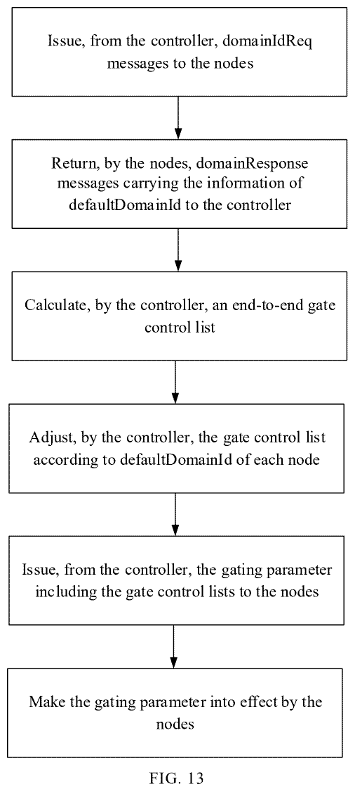

Referring to FIG. 13, a gating scheduling method according to an embodiment of the present disclosure may include:
B1, issuing, by the controller, domainIdReq messages to the nodes;
B2, returning, by the nodes, domainResponse messages carrying the information of defaultDomainId to the controller;
B3, calculating, by the controller, an end-to-end gate control list;
B4, adjusting, by the controller, the gate control list according to defaultDomainId of each node;
B5, issuing, by the controller, the gating parameters including the gate control lists to the nodes; and
B6, making the gating parameters into effect by the nodes.

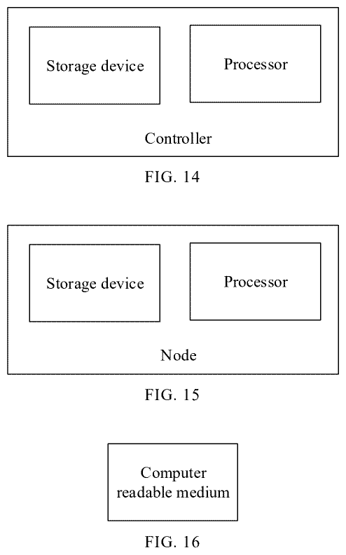

In a third aspect, referring to FIG. 14, an embodiment of the present disclosure provide a controller, including at least one storage device and at least one processor; and the storage device stores a computer program executable by the processor, and when the computer program is executed by the processor, the gating scheduling method according to any embodiment of the present disclosure is implemented.

In a fourth aspect, referring to FIG. 15, an embodiment of the present disclosure provides a node, including at least one storage device and at least one processor; and the storage device stores a computer program executable by the processor, and when the computer program is executed by the processor, the gating scheduling method according to any embodiment of the present disclosure is implemented.

In a fifth aspect, referring to FIG. 16, an embodiment of the present disclosure provides a computer readable medium having stored thereon a computer program which, when executed by a processor, implements the gating scheduling method according to any embodiment of the present disclosure.

The processor is a device having data processing capability, and includes, but is not limited to, a Central Processing Unit (CPU); the storage device is a device having data storage capability, and includes, but is not limited to, a Random Access Memory (RAM, more specifically, a Synchronous Dynamic RAM (SDRAM), a Double Data Rate SDRAM (DDR SDRAM), etc.), a Read-Only Memory (ROM), an Electrically Erasable Programmable Read-Only Memory (EEPROM), and a flash memory (FLASH); and an input/output (I/O) interface (read/write interface) is connected between the processor and the storage device, can enable information interaction between the storage device and the processor, and includes, but is not limited to, a data bus (Bus).

It should be understood by those of ordinary skill in the art that the functional modules/units in all or some of the operations, systems and devices disclosed above may be implemented as software, firmware, hardware, or suitable combinations thereof.

If implemented as hardware, the division between the functional modules/units stated above is not necessarily corresponding to the division of physical components; and for example, one physical component may have a plurality of functions, or one function or operation may be performed through cooperation of several physical components.

Some or all of the physical components may be implemented as software executed by a processor, such as a CPU, a digital signal processor or a microprocessor, or may be implemented as hardware, or may be implemented as an integrated circuit, such as an application specific integrated circuit. Such software may be distributed on a computer-readable medium, which may include a computer storage medium (or a non-transitory medium) and a communication medium (or a transitory medium). As well known by those of ordinary skill in the art, the term “computer storage medium” includes volatile/nonvolatile and removable/non-removable media used in any method or technology for storing information (such as computer-readable instructions, data structures, program modules and other data). The computer storage medium includes, but is not limited to, an RAM (more specifically, an SDRAM, a DDR, etc.), an ROM, an EEPROM, a flash memory or other magnetic disks, a Compact Disc Read Only Memory (CD-ROM), a Digital Versatile Disc (DVD) or other optical discs, a magnetic cassette, a magnetic tape, a magnetic disk or other magnetic storage devices, or any other medium which can be configured to store desired information and can be accessed by a computer. In addition, it is well known by those of ordinary skill in the art that the communication media generally include computer-readable instructions, data structures, program modules, or other data in modulated data signals such as carrier wave or other transmission mechanism, and may include any information delivery medium.

The present disclosure discloses exemplary embodiments using specific terms, but the terms are merely used and should be merely interpreted as having general illustrative meanings, rather than for the purpose of limitation. Unless expressly stated, it is apparent to those of ordinary skill in the art that features, characteristics and/or elements described in connection with a particular embodiment can be used alone or in combination with features, characteristics and/or elements described in connection with other embodiments. Therefore, it should be understood by those of ordinary skill in the art that various changes in the forms and the details can be made without departing from the scope of the present disclosure of the appended claims.

1. A gating scheduling method for a controller connected to a node, comprising:
determining a target gate control list based on a target clock domain; and
issuing target gating parameter to the node, the target gating parameter comprising the target gate control list and a clock domain information parameter, and the clock domain information parameter representing information of a clock domain adopted for the target gate control list.

2. The method of claim 1, wherein
the clock domain information parameter comprises an unspecified identification or a target clock domain identification, the unspecified identification representing that the target gate control list adopts a default clock domain of the node, and the target clock domain identification representing that the target gate control list adopts the target clock domain.

3. The method of claim 1, wherein the clock domain information parameter further comprises:
a type of the target clock domain.

4. A gating scheduling method for a node connected to a controller, comprising:
receiving a target gating parameter issued from the controller, the target gating parameter comprising a target gate control list and a clock domain information parameter, and the clock domain information parameter representing information of a clock domain adopted for the target gate control list;
determining a final gating parameter at least according to the clock domain information parameter in the target gating parameter; and
making the final gating parameter into effect.

5. The method of claim 4, wherein
the clock domain information parameter comprises an unspecified identification or a target clock domain identification, the unspecified identification representing that the target gate control list adopts a default clock domain of the node, and the target clock domain identification representing that the target gate control list adopts a target clock domain.

6. The method of claim 5, wherein the determining the final gating parameter at least according to the clock domain information parameter in the target gating parameter comprises:
responsive to the clock domain information parameter including the unspecified identification, determining the target gating parameter as the final gating parameter;
responsive to the clock domain information parameter including the target clock domain identification and the target clock domain identical to the default clock domain of the node, determining the target gating parameter as the final gating parameter; and
responsive to the clock domain information parameter including the target clock domain identification and the target clock domain different from the default clock domain of the node, determining a timestamp difference between the target clock domain and the default clock domain, and determining the final gating parameter based on the timestamp difference and the target gating parameter.

7. The method of claim 6, wherein the target gating parameter further comprises an effective time of the target gate control list; and
the determining the final gating parameter based on the timestamp difference and the target gating parameter comprises: correcting the effective time in the target gating parameter based on the timestamp difference to obtain the final gating parameter.

8. A controller, comprising at least one storage device and at least one processor; and the storage device stores a computer program executable by the at least one processor, and when the computer program is executed by the at least one processor, the gating scheduling method of claim 1 is implemented.

9. A node, comprising at least one storage device and at least one processor; and the storage device stores a computer program executable by the at least one processor, and when the computer program is executed by the at least one processor, the gating scheduling method of claim 4 is implemented.

10. A non-transitory computer readable medium having stored thereon a computer program which, when executed by a processor, implements the gating scheduling method of claim 1.

11. The controller of claim 8, wherein
the clock domain information parameter comprises an unspecified identification or a target clock domain identification, the unspecified identification representing that the target gate control list adopts a default clock domain of the node, and the target clock domain identification representing that the target gate control list adopts the target clock domain.

12. The controller of claim 8, wherein the clock domain information parameter further comprises: a type of the target clock domain.

13. The node of claim 9, wherein
the clock domain information parameter comprises an unspecified identification or a target clock domain identification, the unspecified identification representing that the target gate control list adopts a default clock domain of the node, and the target clock domain identification representing that the target gate control list adopts a target clock domain.

14. The node of claim 13, wherein the determining the final gating parameter at least according to the clock domain information parameter in the target gating parameter comprises:
responsive to the clock domain information parameter including the unspecified identification, determining the target gating parameter as the final gating parameter;
responsive to the clock domain information parameter including the target clock domain identification and the target clock domain identical to the default clock domain of the node, determining the target gating parameter as the final gating parameter; and
responsive to the clock domain information parameter including the target clock domain identification and the target clock domain different from the default clock domain of the node, determining a timestamp difference between the target clock domain and the default clock domain, and determining the final gating parameter based on the timestamp difference and the target gating parameter.

15. The node of claim 14, wherein the target gating parameter further comprises an effective time of the target gate control list; and
the determining the final gating parameter based on the timestamp difference and the target gating parameter comprises: correcting the effective time in the target gating parameter based on the timestamp difference to obtain the final gating parameter.
